(19) United States
(12) Patent Application Publication
(10) Pub. No.: US 2003/0016902 A1
(43) Pub. Date: Jan. 23, 2003

(54) High speed optical on/off switch

(76) Inventor: Mei Yan, Cupertino, CA (US)

Correspondence Address: Bo-In Lin, 13445 Mandoli Drive, Los Altos Hills, CA, 94022, US

(21) Appl. No.: 09/907,199

(22) Filed: Jul. 17, 2001

(51) Int. Cl. G02B 6/35

(52) U.S. Cl. 385/16; 385/11

(57) ABSTRACT

A new optical on/off switch design with a fast switching speed of about a few micron seconds is disclosed in this invention. The core of the new optical on/off switch is a standard optical isolator in which a latching magnetized Faraday rotator is used. The latching Faraday rotator has a fast switching speed, i.e., about a few micron seconds, between magnetized and non-magnetized states under the effect of an external magnetic field. To realize the switching function, an electrically controlled external magnetic field is applied on the latching Faraday rotator. When a forward electric current pulse and thus a forward external magnetic field are applied onto latching Faraday rotator, the latching Faraday rotator reaches the state of the forward saturated rotation (the forward transmission state of an optical isolator) and thus an optical signal passes through. When a reverse electric current pulse and thus a reverse external magnetic field are applied onto latching Faraday rotator, the latching Faraday rotator reaches the state of the reverse saturated rotation (the isolation state of an optical isolator) and thus an optical signal is blocked.

### FIELD OF THE INVENTION

This invention relates generally to a method and system for use in optical fiber technology. More particularly, this invention relates to an apparatus and method for providing an optical on/off switch with a switching speed of about a few microseconds.

### BACKGROUND OF THE INVENTION

Optical switches, which are used to block and change the optical transmission paths of optical signals are commonly employed in optical fiber communications. For example, optical on/off switches, which are used to pass and block optical signal transmission, are being broadly used to protect optical receivers and amplifiers from possible damages caused by strong optical signal pulses. For this kind of applications, it is required that the optical on/off switches have a high switching speeds, i.e., micro seconds or faster, and are also latching for maintaining at a on-off state without requiring continuously applying electric power.

There are currently several kinds of optical on/off switches, including mechanical based, liquid crystal based and electronic based switches. All these switches have relatively slow switching speeds ranging from sub-milliseconds to few milliseconds and thus cannot provide effective protections required for the above protection applications. FIG. 1 shows the structure of a typical mechanical optical on/off switch. The mechanical optical on/off switch includes an input optical collimator 20 with an input optical fiber 10, an optical blocking element 30, a mechanical blocking element driving motor 40, and an output optical collimator 60 with an output optical fiber 70. In the mechanical optical on/off switch, an optical signal 50 transmits from the input optical collimator 20 to the output optical collimator 60. The mechanical blocking element driving motor 40 moves the physical position of the optical blocking element 30. When the optical blocking element 30 is moved onto the transmission path, the optical signal 50 will be blocked and thus the mechanical optical on/off switch is in the off state. When the optical blocking element 30 is moved away from the transmission path, the optical signal 50 will pass through and thus the mechanical optical on/off switch is in the on state. In the mechanical optical on/off switch, switching is realized by mechanically moving the optical blocking element 30 in and out the optical signal transmission path and thus switching speed is relatively slow, i.e., in the order of mini seconds. Thus, the mechanical optical on/off switches cannot meet the switching speed requirements for the above protection applications.

Therefore, a need exists in the art of design the optical on/off switch to overcome the difficulties discussed above. Specifically, a design to provide the optical on/off switch with a significantly improved switching speed is required. Since production costs have been an important factor prohibiting practical implementation of optical fiber technology, it is also highly desirable that the cost of such design would be as low as possible.

### SUMMARY OF THE PRESENT INVENTION

It is therefore an object of the present invention to provide a new design for an optical on/off switch with a fast switching speed of about a few micron seconds. Therefore, the aforementioned difficulties and limitations in the prior art can be resolved.

Specifically, it is an object of the present invention to provide a new optical on/off switch design based on the operation principle of an optical isolator. The new optical on/off switch employs an optical isolator in which a latching magnetized Faraday rotator is used. The latching magnetized Faraday rotator has a fast switching speed, i.e., about a few micron seconds, between opposite magnetized states controlled by an external magnetic field. By electrically controlling the polarization of the external magnetic field, the new optical on/off switch can achieve a fast on/off switching speed of about a few microseconds.

Briefly, in a preferred embodiment, the present invention discloses a new optical on/off switch design with a fast switching speed of about a few micron seconds. The core of the new optical on/off switch is a standard optical isolator in which a latching magnetized Faraday rotator is used. The latching Faraday rotator has a fast switching speed, i.e., about a few micron seconds, between opposite magnetized states under the effect of an external magnetic field. To realize the switching function, an electrically controlled external magnetic field is applied on the latching Faraday rotator. When a forward electric current pulse and thus a forward external magnetic field are applied onto latching Faraday rotator, the latching Faraday rotator reaches the state of the forward saturated rotation (the forward transmission state of an optical isolator) and thus an optical signal passes through. When a reverse electric current pulse and thus a reverse external magnetic field are applied onto latching Faraday rotator, the latching Faraday rotator reaches the state of the reverse saturated rotation (the isolation state of an optical isolator) and thus an optical signal is blocked.

These and other objects and advantages of the present invention will no doubt become obvious to those of ordinary skill in the art after having read the following detailed description of the preferred embodiment which is illustrated in the various drawing figures.

### BRIEF DESCRIPTION OF THE DRAWINGS

FIG. 1 is the structure of a typical mechanical optical on/off switch;

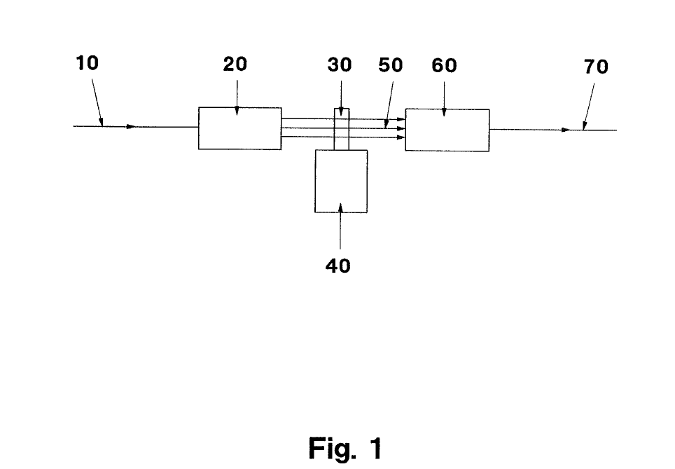

FIG. 2 is the structure of the optical on/off switch according to the present invention;

FIGS. 3A and 3B illustrate the operation of the optical on/off switch according to the present invention;

FIG. 4 is the detailed structure of the optical on/off switch in a preferred embodiment according to the present invention; and

FIG. 5 is the structure of the optical on/off switch in another preferred embodiment according to the present invention.

### DETAILED DESCRIPTION OF THE PREFERRED EMBODIMENT

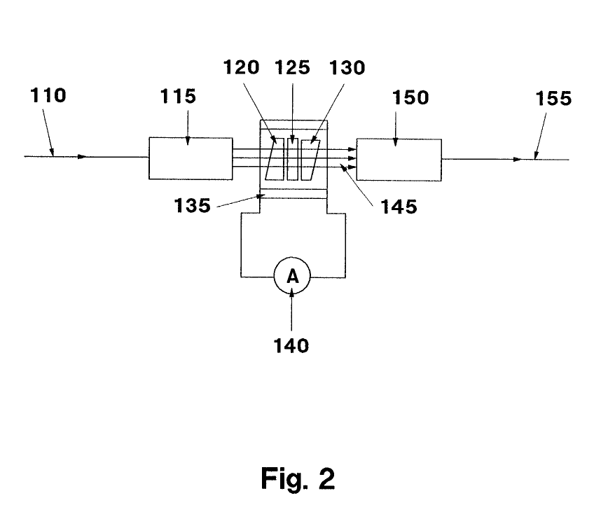

The present invention discloses an optical on/off switch with a fast switching speed that is provided to switch on and off the transmission of an optical signal in about a few micron seconds (μs). Referring to FIG. 2 for a preferred embodiment of an optical on/off switch 100 of this invention. The optical on/off switch 100 has an input optical collimator 115 with an input optical fiber 110 to receive an incident optical signal. The input collimator 115 generates collimated beams for projecting to an input birefringent polarizer 120 then passing through a latching Faraday rotator 125 then transmitted through an output birefringent polarizer 130. An electric wire coil 135 surrounds the input birefringent polarizer 120, the latching Faraday rotator and the output birefringent polarizer 130. The electric wire coil 135 is connected to an electric current driver 140. The detail functions performed by the electric wire coil 135 and the current driver 140 will be further described below. After the collimated beam passes through the output birefringent polarizer 130, it is projected to an output collimator 150 for generating an output signal for transmitting through an output optical fiber 155.

The input and output birefringent polarizers 120 and 130 are composed of a birefringent material such as LiNbO₃, rutile, calcite or YVO₄. There is an angular difference of 45° between the optical axes of the input and output birefringent polarizers 120 and 130. The latching Faraday rotator 125 is a standard latching magnetized 45° Faraday rotator such as K1- or K2-type latching magnetized 45° Faraday rotators produced and marketed by Mitsubishi International. The latching Faraday rotator 125 has a fast switching speed, i.e., about a few microseconds, between different magnetized states under the effect of an external big magnetic field. When an external forward magnetic field of significant field flux density is applied on the latching Faraday rotator 125, the latching Faraday rotator 125 reaches a saturated state providing a clockwise rotation state of 45°. On the other hand, when an external reverse magnetic field with sufficient magnetic flux density is applied on the latching Faraday rotator 125, the latching Faraday rotator 125 is quickly switched from the saturated clockwise rotation state of 45° to the saturated anti-clockwise rotation state of 45°. By switching on/off the electric current driver, the electric current on the electric wire coil is adjusted to forward and reverse flow directions respectively. Therefore, by switching on/off the electric current driver 140, the electric wire coil 135 provides an external forward/reverse adjustment of the magnetic field applied on the latching Faraday rotator 125.

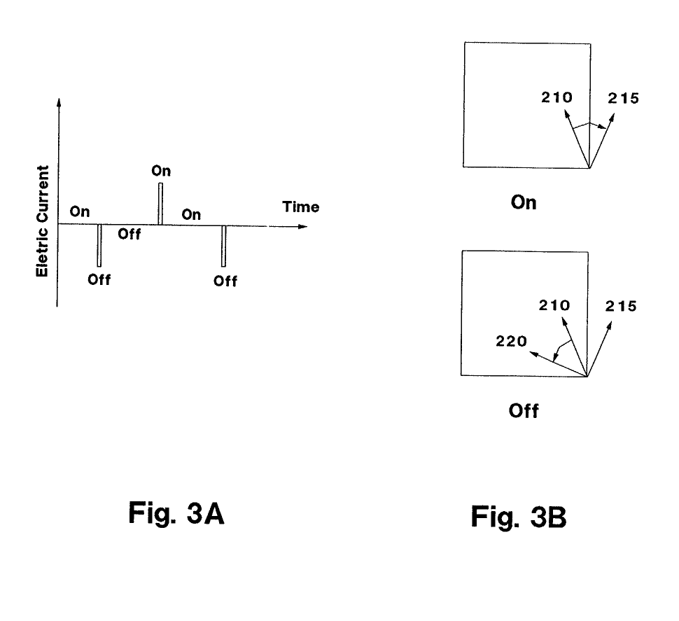

Referring to FIGS. 3A and 3B for the operation principle of the optical on/off switch 100 of this invention. FIG. 3A shows the on/off switching of the optical transmission by forward/reverse switching the electric current driver 140. The magnitude of the electric current sufficient to switch the magnetization state of the Faraday rotator 125 is determined by the operational characteristics of the latching Faraday rotator 125 and the number of turns and the distance between the wire coil 135 and the latching Faraday rotator 125. FIG. 3B shows the polarization rotation of the latching Faraday rotator 125 during the forward/reverse switching of the electric current driver 140 and the angular relation to the optical axes of the input and output birefringent polarizers 120 and 130 for switching on/off the optical transmission. In FIG. 3B, arrows 210 and 215 show respectively the optical axis of the input and output birefringent polarizer 120 and 130. There is an angular difference of 45° between the optical axes 210 and 215 of the input and output birefringent polarizers 120 and 130.

Referring back to FIG. 2, an optical signal 145 projected from the input optical collimator 115 is first polarized by the input birefringent polarizers 120. When a forward electric current pulse is turned on and a forward magnetic field is applied on the latching Faraday rotator 125, the polarization of the optical signal 145 projected from output birefringent polarizer is rotated 45° clockwise to match with that of the output birefringent polarizer 130. Then the optical signal 145 will pass through the output birefringent polarizer 130 and enter the output optical collimator 150. The optical on/off switch is in the on state. However, when a reverse electric current pulse is turned on and a reverse magnetic field is applied on the latching Faraday rotator 125, the polarization of the optical signal 145 is rotated 45° anti-clockwise and become perpendicular to that of the output birefringent polarizer 130. Then the optical signal 145 will not pass through the output birefringent polarizer 130 and be blocked. The output beam is prevented from entering into the output optical collimator 150. The optical on/off switch is in the off state. Since the latching Faraday rotator 125 has a fast switching speed of about a few micron seconds from the forward magnetized state to the reverse magnetized state, the optical on/off switch has a fast on/off switching speed of about a few micron seconds. Furthermore, since the Faraday rotator 125 is a latching rotator, the latching Faraday rotator will remain at its magnetized state even after the applied electric current and the magnetic field is turned off. For that reason, the optical on/off switch 100 is a latching switch and will remain at its on or off state even after the applied electric current and thus magnetic field is turned off. When the optical switch 100 is operated, it is only required to apply an electric current pulse to switch the optical on/off switch 100 from the on state to the off state. This will save the power consumption and thus the operation cost of the optical on/off switch 100.

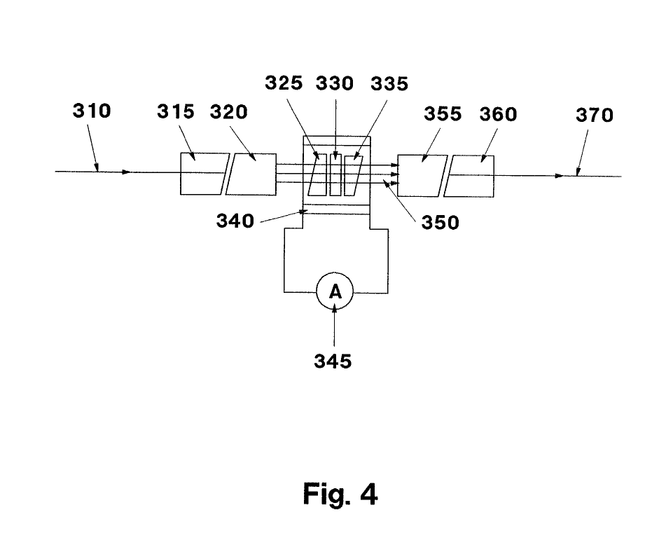

Referring to FIG. 4 for a detailed structure of the optical on/off switch of this invention. In FIG. 4, the input optical collimator is made using an input single-fiber pigtail 315 and an input GRIN lens 320 and the output optical collimator is made using an output single-fiber pigtail 360 and an output GRIN lens 355.

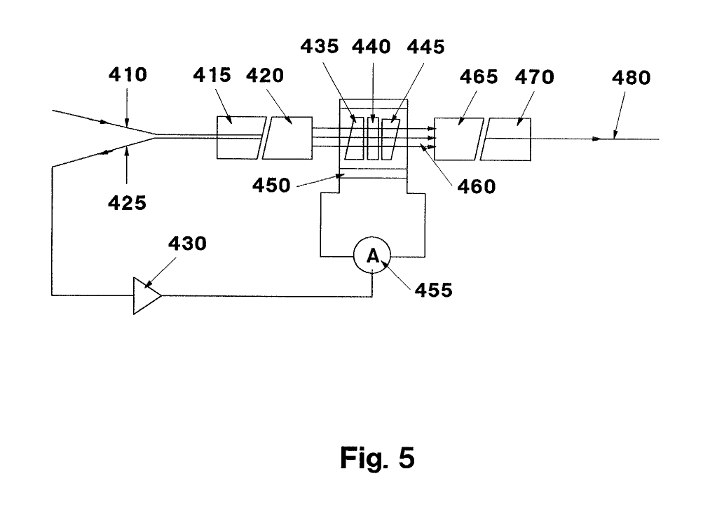

Referring to FIG. 5 for the structure of the optical on/off switch in another preferred embodiment according to the present invention. As we discuss above, the optical on/off switch of the present invention is implemented to protect the optical receivers and amplifiers from possible damages caused by strong optical signal pulses. For the purpose of device protection, an optical power monitor is employed to monitor the power of optical signals. When the power monitor detects a strong optical signal, the power monitor sends a controlling signal to the electric current driver of the optical on/off switch of the present invention. The optical on/off switch is turned off to block the strong optical signals from damaging the optical receivers and amplifiers. FIG. 5 illustrates a system configuration implemented with of the optical on/off switch as disclosed by the present invention and the optical power monitor. In FIG. 5, a special GRIN lens 420 is employed. The front flat surface of the special GRIN lens 420 has a special optical coating. The special coating layer can reflect a small portion (1-5%) of an optical signal from an input optical fiber 410 into an output optical fiber 425 while majority portion of the optical signal passes through the special GRIN lens 420. The output optical fiber 425 is connected to an optical power monitor 430. When the optical power monitor 430 detects a strong optical signal, the power monitor sends a controlling signal to an electric current driver 455 to turn off the optical switch to block the transmission of the strong optical signal from damaging optical the receivers and amplifiers. While the optical on/off switch shown in FIG. 5 performs the function of optical power monitoring, it also has a lower cost as compared to the sum of costs of an optical on/off switch and an optical power monitor.

According to above descriptions, this invention discloses an optical on/off switch. The switch includes an input collimating means for receiving an input optical signal and generating an input collimated beam. The switch further includes a latching Faraday rotator disposed between an input birefringent polarizer and an output birefringent polarizer for receiving the collimated beam. The switch further includes an electric pulse means for generating a current pulse for changing a polarization state of the latching Faraday rotator for on-off switching a transmission of the collimated beam through the output birefringent polarizer. In a preferred embodiment, the switch further includes an output collimating means for receiving and collimating an optical beam pass through the output birefringent polarizer. In another preferred embodiment, the switch further includes an input power detector for detecting an input power of the input optical signal for controlling the electric pulse means for on-off switching a transmission of the collimated beam. In another preferred embodiment, the switch further includes an input signal tapping means for tapping a portion of the input optical signal to the input power detector for detecting an input power of the input optical signal. In another preferred embodiment, the electric pulse means further includes a coil surrounding the latching Faraday rotator connected to a current driver for generating an current pulse for changing a polarization state of the latching Faraday rotator. In another preferred embodiment, the input birefringent polarizer and the output birefringent polarizer having two different optical axes with a phase difference of forty-five degrees. And the latching Faraday rotator is controlled by the electric pulse means for rotating a polarization of the collimated beam along a clockwise or counterclockwise direction by forty-five degrees. In another preferred embodiment, the input collimating means further includes a first optical pigtail and a first GRIN lens. And, the output collimating means further includes a second optical pigtail and a second GRIN lens. In another preferred embodiment, the input collimating means further includes a tapped optical pigtail for tapping a portion of the input optical signal for transmitting to the input power detector for detecting an input power of the input optical signal. In another preferred embodiment, tire input collimating means further includes a GRIN lens for reflecting the portion of input optical signal to the tapped optical pigtail for transmitting to the input power detector for detecting an input power of the input optical signal.

In summary, this invention discloses an optical on/off switch that includes an on/off optical isolator controlled by an electromagnetic means for on/off switching an optical transmission therethrough. In a preferred embodiment, the on/off optical isolator further includes a latching Faraday rotator controlled by the electromagnetic means for switching a polarization rotation-state. In another preferred embodiment, the on/off optical isolator further comprising an input birefringent polarizer and an output birefringent polarizer with the Faraday rotator disposed between the input and output birefringent polarizer. In yet another preferred embodiment the input birefringent polarizer and the output birefringent polarizer having two different optical axes with a phase difference of forty-five degrees and the latching Faraday rotator is controlled by the electromagnetic means for rotating the polarization rotation-state along a clockwise or counterclockwise direction by forty-five degrees. In another preferred embodiment, the on-off switch further includes an input power detector for detecting an input power of an input optical signal for controlling the electromagnetic means for on/off switching the on/off optical isolator. In another preferred embodiment, the electromagnetic means further comprising a pulse current means connected to a current driver for switching a polarization rotation-state of the latching Faraday rotator.

This invention further discloses a method for on/off switching an optical transmission. The method includes a step of controlling an on/off optical isolator by an electromagnetic means for on/off switching an optical transmission therethrough. In a preferred embodiment, the step of controlling the on/off optical isolator further comprising a step of controlling a latching Faraday rotator by employing the electromagnetic means for switching a polarization rotation-state of the latching Faraday rotator. In another preferred embodiment, the step of controlling the on/off optical isolator further comprising a step of disposing the latching Faraday rotator between an input birefringent polarizer and an output birefringent polarizer. In another preferred embodiment, the step of disposing the latching Faraday rotator between the input birefringent polarizer and the output birefringent polarizer further includes a step of employing the input birefringent polarizer and the output birefringent polarizer having two different optical axes with a phase difference of forty-five degrees. And, controlling the latching Faraday rotator by the electromagnetic means for rotating the polarization rotation-state along a clockwise or counterclockwise direction by forty-five degrees. In another preferred embodiment, the method further includes a step of detecting an input power of an input optical signal by employing an input power detector for controlling the electromagnetic means for on-off switching the on/off optical isolator. In another preferred embodiment, the step of controlling the on/off switch by employing the electromagnetic means further includes a step of controlling the on/off switching by employing a pulse current means connected to a current driver for switching a polarization rotation-state of the latching Faraday rotator.

Although the present invention has been described in terms of the presently preferred embodiment, it is to be understood that such disclosure is not to be interpreted as limiting. Various alternations and modifications will no doubt become apparent to those skilled in the art after reading the above disclosure. Accordingly, it is intended that the appended claims be interpreted as covering all alternations and modifications as fall within the true spirit and scope of the invention.

We claim:

1 An optical on/off switch comprising:
an input means for receiving an input optical signal and generating an input beam;
a latching Faraday rotator disposed between an input birefringent polarizer and an output birefringent polarizer for receiving said beam; and
a means for applying a magnetic field for changing a rotation angle of said latching Faraday rotator.

2 The optical on/off switch of claim 1 further comprising:
an output means for receiving an optical beam to pass through said output birefringent polarizer.

3 The optical on/off switch of claim 1 further comprising:
an input power detector for detecting an input power of said input optical signal for controlling said means for applying said magnetic field for on-off a transmission of said optical beam.

4 The optical on/off switch of claim 3 further comprising:
an input signal tapping means for tapping a portion of said input optical signal to said input power detector for detecting an input power of said input optical signal.

5. The optical on/off switch of claim 1 wherein:
said means for applying said magnetic field further includes a coil surrounding said latching Faraday rotator connected to a current driver for generating an current pulse for changing a rotation angle of said latching Faraday rotator.

6. The optical on/off switch of claim 1 wherein:
said input birefringent polarizer and said output birefringent polarizer having different optical axes with a difference of forty-five degrees and said latching Faraday rotator is controlled by said means for applying said magnetic field for rotating a polarization direction of said beam along a clockwise or counterclockwise direction by forty-five degrees.

7. The optical on/off switch of claim 1 wherein:
said input collimating means further includes a first optical pigtail and a first GRIN lens.

8. The optical on/off switch of claim 1 wherein:
said output means further includes a second optical pigtail and a second GRIN lens.

9. The optical on/off switch of claim 3 wherein:
said input means further includes a tapped optical pigtail for tapping a portion of said input optical signal for transmitting to said input power detector for detecting an input power of said input optical signal.

10. The optical on/off switch of claim 9 wherein:
said input means further includes a GRIN lens for reflecting said portion of input optical signal to said tapped optical pigtail for transmitting to said input power detector for detecting an input power of said input optical signal.

11. An optical on/off switch comprising:
a switchable optical isolator controlled by an electromagnetic means for on/off switching an optical transmission therethrough.

12. The optical on/off switch of claim 11 wherein:
said switchable optical isolator further comprising a latching Faraday rotator controlled by said electromagnetic means for switching a polarization rotation-state.

13. The optical on/off switch of claim 12 wherein:
said switchable optical isolator further comprising an input birefringent polarizer and an output birefringent polarizer with said latching Faraday rotator disposed between said input and output birefringent polarizer.

14. The optical on/off switch of claim 13 wherein:
said input birefringent polarizer and said output birefringent polarizer having different optical axes with a difference of forty-five degrees and said latching Faraday rotator is controlled by said electromagnetic means for rotating said polarization rotation-state along a clockwise or counterclockwise direction by forty-five degrees.

15. The optical on/off switch of claim 11 further comprising:
an input power detector for detecting an input power of an input optical signal for controlling said electromagnetic means for on-off switching said switchable optical isolator.

16. The optical on/off switch of claim 12 wherein:
said electromagnetic means further comprising a pulse current means connected to a current driver for switching a polarization rotation-state of said latching Faraday rotator.

17. A method for on/off switching an optical transmission comprising:
controlling a switchable optical isolator by an electromagnetic means for on/off switching an optical transmission therethrough.

18. The method of claim 17 wherein:
said step of controlling said switchable optical isolator further comprising a step of controlling a latching Faraday rotator by employing said electromagnetic means for switching a polarization rotation-state of said latching Faraday rotator.

19. The method of claim 18 wherein:
said step of controlling said switchable optical isolator further comprising a step of disposing said latching Faraday rotator between an input birefringent polarizer and an output birefringent polarizer.

20. The method of claim 19 wherein:
said step of disposing said latching Faraday rotator between said input birefringent polarizer and said output birefringent polarizer further comprising a step of employing said input birefringent polarizer and said output birefringent polarizer having different optical axes with a difference of forty-five degrees and controlling said latching Faraday rotator by said electromagnetic means for rotating said polarization rotation-state along a clockwise or counterclockwise direction by forty-five degrees.

21. The method of claim 17 further comprising:
detecting an input power of an input optical signal by employing an input power detector for controlling said electromagnetic means for on-off switching said switchable optical isolator.

22. The method of claim 18 wherein:
said step of controlling said switchable isolator by employing said electromagnetic means further comprising a step of controlling said switchable isolator by employing a pulse current means connected to a current driver for switching a polarization rotation-state of said latching Faraday rotator.
